(19) United States
(12) Patent Application Publication
(10) Pub. No.: US 2012/0269354 A1
(43) Pub. Date: Oct. 25, 2012

(54) SYSTEM AND METHOD FOR STREAMING MUSIC REPAIR AND ERROR CONCEALMENT

(75) Inventors: Jonathan Paul Doherty, Londonderry (GB); Kevin Curran, Eglinton (GB); Paul Mckevitt, Londonderry (GB)

(73) Assignee: UNIVERSITY OF ULSTER, Coleraine (GB)

(21) Appl. No.: 13/321,795

(22) PCT Filed: May 20, 2010
(86) PCT No.: PCT/EP10/57014

§ 371 Date: Jan. 11, 2012

(30) Foreign Application Priority Data
May 22, 2009 (GB) 0908879.0

(51) Int. Cl. G10L 19/02

(52) U.S. Cl. 381/56

(57) ABSTRACT

A method is provided for analysing the self-similarity of an audio file. The method involves obtaining the audio spectrum envelope data of an audio file to be analysed; performing a clustering operation on the spectrum envelope data to produce a clustered set of data; for a first portion of the clustered data, performing a string matching operation on at least one other portion of the clustered data; and based on the results of the string matching operation, determining the at least one other portion of the clustered data most similar to said first portion of the clustered data. There is also provided a method of repairing an audio stream received over a network using similarity data to replace damaged or missing portions of data with similar “good” portions of data.

### FIELD OF THE INVENTION

This invention relates to a system and method for error concealment and repair in streaming music.

### BACKGROUND OF THE INVENTION

Streaming media across the Internet is still a relatively unreliable and poor quality medium. Services such as audio-on-demand drastically increase the load on the networks, and therefore new, robust and highly efficient coding algorithms are necessary. One overlooked method to date, which can work alongside existing audio compression schemes, is to take account of the semantics and natural repetition of music in the category of Western Tonal Format. Similarity detection within polyphonic audio has presented problematic challenges within the field of Music Information Retrieval (MIR). One approach to deal with bursty errors is to use self-similarity to replace missing segments. Many existing systems exist based on packet loss and replacement on a network level but none attempt repairs of large dropouts of 5 seconds and over.

Streaming media across the Internet is still an unreliable and poor quality medium. Current technologies for streaming media have gone as far as they can in regards to compression (both lossy and lossless) and buffering songs streamed from a web based server to clients. It is anticipated that in future we will witness the next revolution through telecommunications technology. In the past two decades the communications sector was one of the few constantly growing sectors in industry and a wide variety of new services were created.

Digital and powerful communication networks are being discussed, planned or under construction. Services such as audio-on-demand drastically increase the load on the networks. The spread of the newly created compression standards such as MPEG-4 reflect the current demand for data compression. As these new services become available the demand of audio services through mobiles has increased. The technology for these services is available but suitable standards are yet to be defined. This is due to the nature of mobile radio channels, which are more limited in terms of bandwidth and bit error rates as for example the public telephone network. Therefore new, robust and highly efficient coding algorithms will be necessary.

Audio, due to its timely nature requires guarantees that are very different in nature with regards to delivery of data from TCP traffic for ordinary HTTP requests. In addition, audio applications increase the set of requirements in terms of throughput, end-to-end delay, delay jitter and synchronization.

Applications such as Microsoft's Media Player and Real Audio have yet to overcome the problems attributed to using a network that is built upon a technology that does not rely on the order the information is sent, but more so the speed at which it travels. Despite a seemingly unlimited bandwidth, a Quality of Service protocol in place and high rates of compression, temporal aliasing still occurs giving the client a poor/unreliable connection where audio playback is patchy when unsynchronised packets arrive.

Streaming media across networks has been a focus for much research in the area of lossy/lossless file compression and network communication techniques. However, the rapid uptake of wireless communication has led to more recent problems being identified. Traffic on a wireless network can be categorised in the same way as cabled networks. File transfers cannot tolerate packet loss but can take an undefined length of time. ‘Real-time’ traffic can accept packet loss (within limitations) but must arrive at its destination within a given time frame. Forward error correction (FEC), which usually involves redundancy built into the packets, and automatic repeat request (ARQ) (Perkins et al., 1998) are two main techniques currently implemented to overcome the problems encountered. However bandwidth restrictions limit FEC solutions and the ‘real-time’ constraints limit the effectiveness of ARQ.

The increase in bandwidths across networks should help to alleviate the congestion problem. However, the development of audio compression including the more popular formats such as Microsoft's Windows Media Audio WMA and the MPEG group's mp3 compression schemes have peaked and yet end users want higher and higher quality through the use of lossless compression formats on more unstable network topologies. When receiving streaming media over a low bandwidth wireless connection, users can experience not only packet losses but also extended service interruptions. These dropouts can last for as long as 15 to 20 seconds. During this time no packets are received and, if not addressed, these dropped packets cause unacceptable interruptions in the audio stream. A long dropout of this kind may be overcome by ensuring that the buffer at the client is large enough. However, when using fixed bit rate technologies such as Windows Media Player or Real Audio a simple packet resend request is the only method of audio stream repair implemented.

The papers “Introducing Song Form Intelligence into Streaming Audio” (Kevin Curran, Journal of Computer Science 1 (2): 164-168, 2005) and “Song Form Intelligence for Streaming Music across Wireless Bursty Networks” (Jonathan Doherty, Kevin Curran, Paul Mc Kevitt; Proceedings of the 16th Irish Conference on Artificial Intelligence and Cognitive Science (AICS '05); September 2005) propose a server-client based framework for automatic detection and replacement of large packet loss on wireless networks when receiving time-dependent streamed audio. The system provides a self-similarity identification and audio replacement system which swaps audio presented to the listener between a live stream and previous sections of the same audio stored locally when dropouts occur. However, a system has not been developed to feasibly implement this approach for real-life conditions.

It is an object of the invention to provide an efficient and effective implementation of a system and method for error concealment and repair in streaming music.

### SUMMARY OF THE INVENTION

Accordingly, there is provided a method of analysing the self-similarity of an audio file, the method comprising the steps of:
obtaining the audio spectrum envelope data of an audio file to be analysed;
performing a clustering operation on the spectrum envelope data to produce a clustered set of data;
for a first portion of the clustered data, performing a string matching operation on at least one other portion of the clustered data; and
based on the results of the string matching operation, determining the at least one other portion of the clustered data most similar to said first portion of the clustered data.

This method allows for the efficient computation of music self-similarity, which can be used to implement a streaming music repair system.

Preferably, said string matching operation is carried out on the portions of said clustered data preceding said first portion.

When music is being streamed, the repair and replacement operations will typically utilise those portions of the audio stream that have been already received.

Preferably, said step of obtaining the audio spectrum envelope comprises:
obtaining an audio file to be analysed; and
extracting the audio spectrum envelope data of said audio file.

Preferably, said method further comprises the step of creating a self-similarity record for said audio file, the self-similarity record containing details of the most similar portion of the clustered data for each portion of said audio file.

Alternatively, said method comprises the step of appending said audio file with a tag, the tag including details of the most similar portion of the clustered data for each portion of said audio file.

The similarity can be recorded in metadata associated with the audio file, e.g. XML tags of an MPEG-7 file, or can simply be stored as a separate file which is transmitted along with a streamed audio file.

Preferably, the method further comprises the step of transmitting the audio file and substantially simultaneously transmitting the self-similarity record across a network to a user for playback.

Preferably, the clustering operation is a K-means clustering operation.

Preferably, the cluster number is chosen from the range 30-70. Preferably, the cluster number is chosen from the range 45-55. More preferably, the cluster number is 50.

Preferably, the cluster starting points are equally spaced across the data.

Preferably, the audio spectrum envelope is chosen to have a hop size of between 1 ms-20 ms. More preferably, the audio spectrum envelope is chosen to have a 10 ms hop size.

Preferably, the number of frequency bands of the audio spectrum envelope is chosen to be between 6-10. Most preferably, the audio spectrum envelope is chosen to have 8 frequency bands.

Preferably, the clustering operation uses the Euclidian distance metric.

Preferably, for the string matching operation, the distance between compared strings is measured in an ordinal scale.

Preferably, the distance between compared strings is measured using the hamming distance.

There is further provided a method of repairing an audio stream transmitted over a network based on self-similarity, the method comprising the steps of:
receiving an audio stream over a network;
receiving similarity data detailing the at least one other portion of the audio stream most similar to a given portion of said audio stream;
when a network error occurs for a portion of the audio stream, replacing said portion of said audio stream with that portion of the audio stream most similar to said portion, based on said similarity data.

The method is particularly useful where the network is a “bursty” network, i.e. the data tends to arrive in bursts rather than at a smooth and constant rate

There is also provided a computer-readable storage medium having recorded thereon instructions which, when executed on a computer, are operable to implement the steps of one or both of the methods outlined above.

### DETAILED DESCRIPTION OF THE INVENTION

An embodiment of the invention will now be described, by way of example only, with reference to the accompanying drawings, in which:

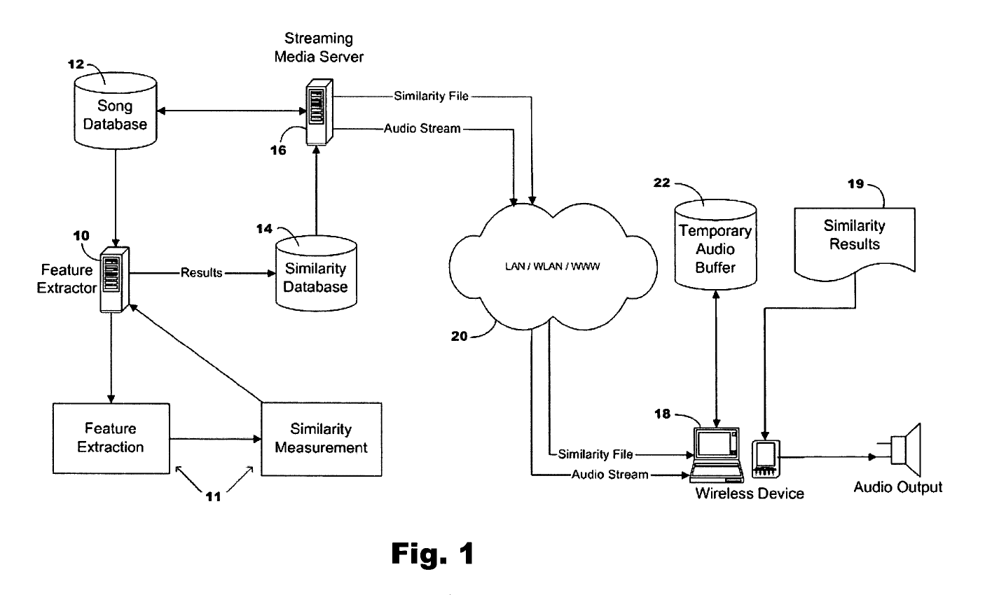

FIG. 1 is a general overview of the system of the invention;

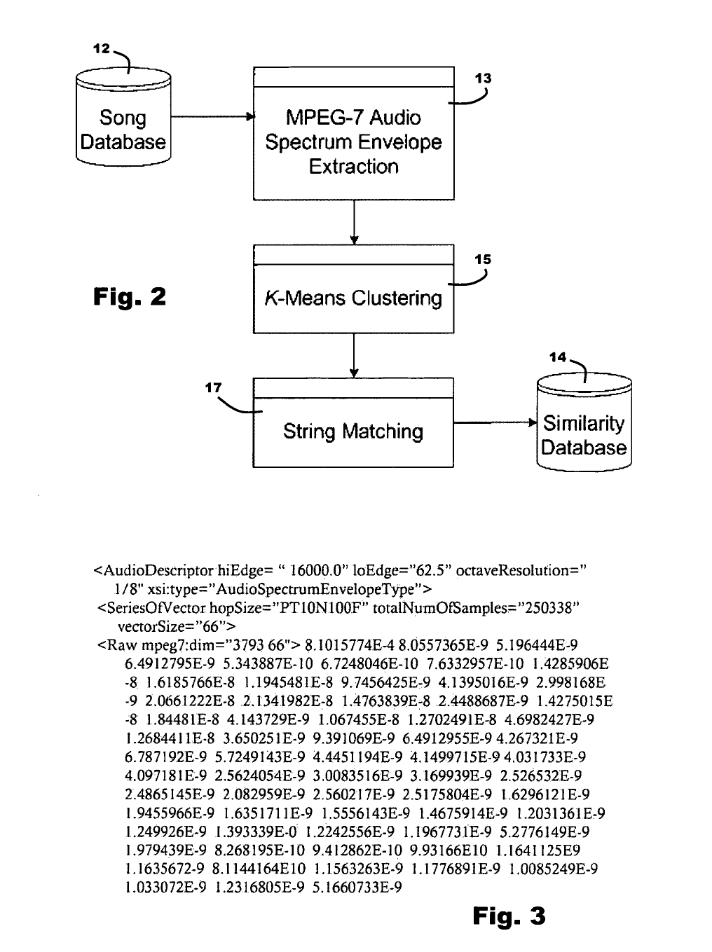

FIG. 2 is a flow diagram of the system of the invention for identifying similarity in an audio file;

FIG. 3 shows a portion of a sample MPEG-7 XML output of the Audio Spectrum Envelope (ASE) of a music file;

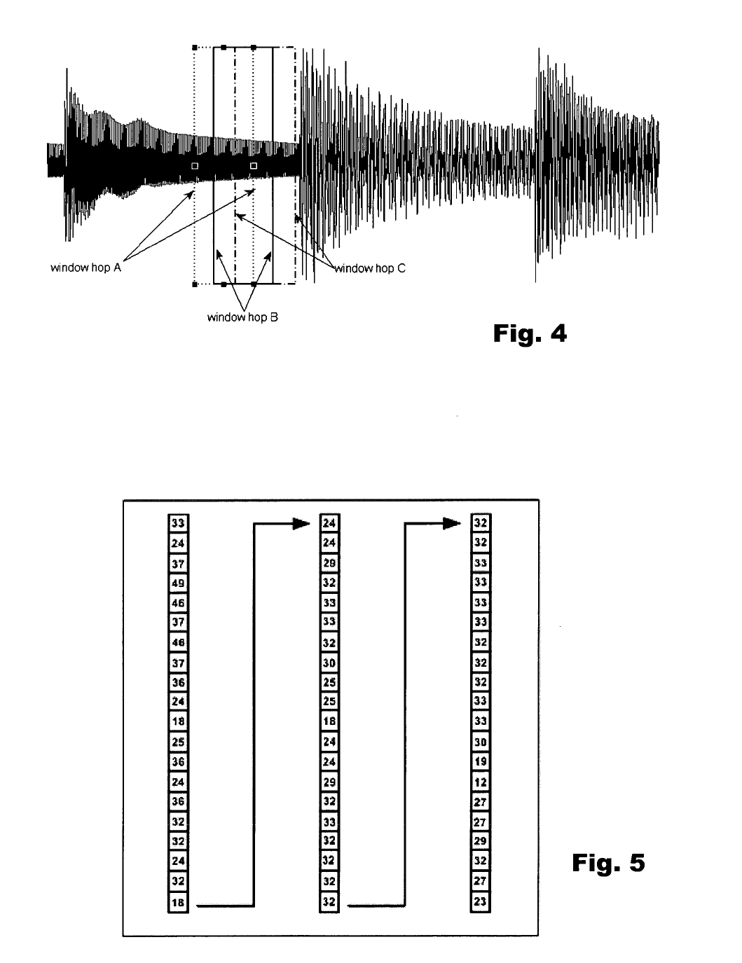

FIG. 4 shows the overlapping of sampling frames for a sample waveform;

FIG. 5 shows a sample output for K-means clustering performed on the ASE data of a sample audio file;

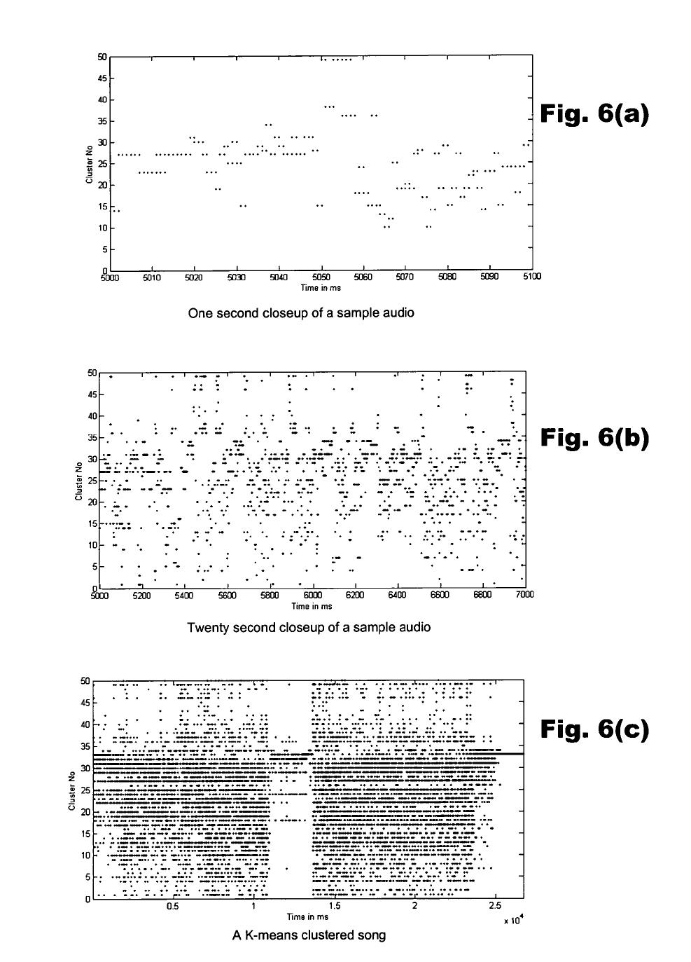

FIG. 6 shows a sample K-means cluster representation of a song for varied time frame windows;

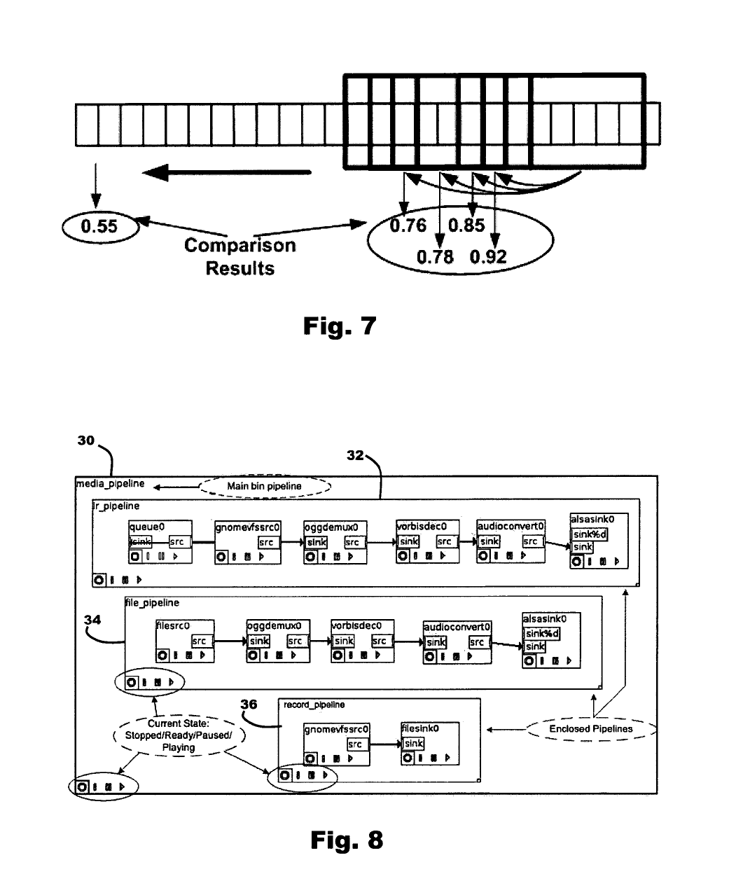

FIG. 7 shows an example of a backward string matching search;

FIG. 8 illustrates a graphical representation of a media handler application with multiple pipelines;

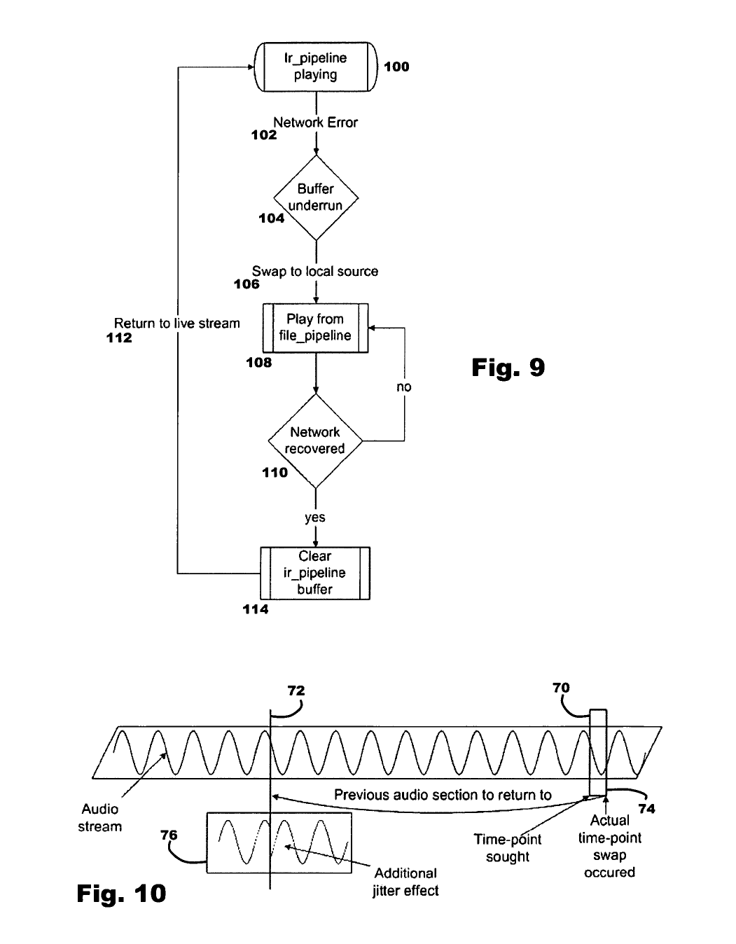

FIG. 9 illustrates the process flow used to determine switching between pipelines;

FIG. 10 illustrates the time delay effect when swapping sources;

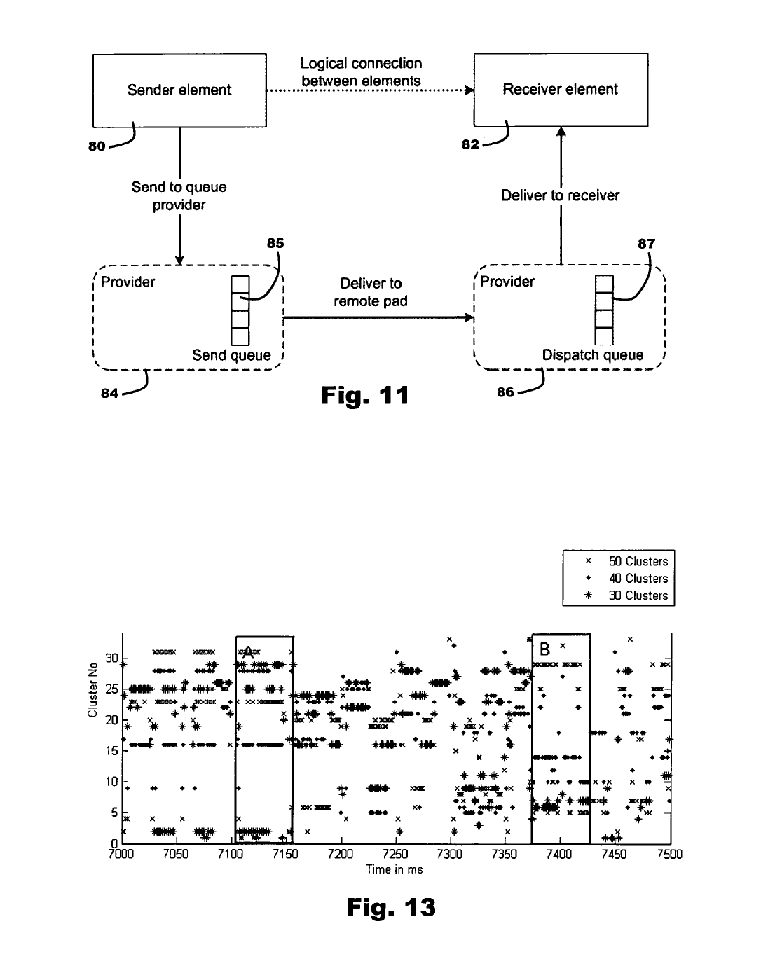

FIG. 11 shows a graphic representation of the time delay effect when swapping audio sources;

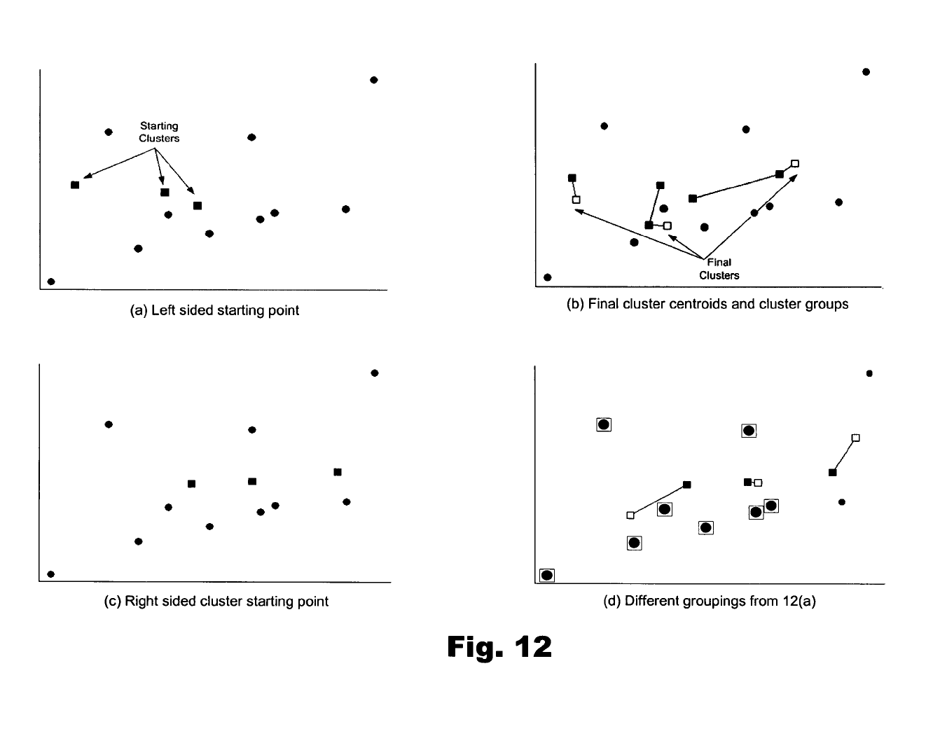

FIG. 12 shows a K-means clustering comparison, when starting points are varied;

FIG. 13 shows a further K-means clustering comparison, when different cluster sizes are selected;

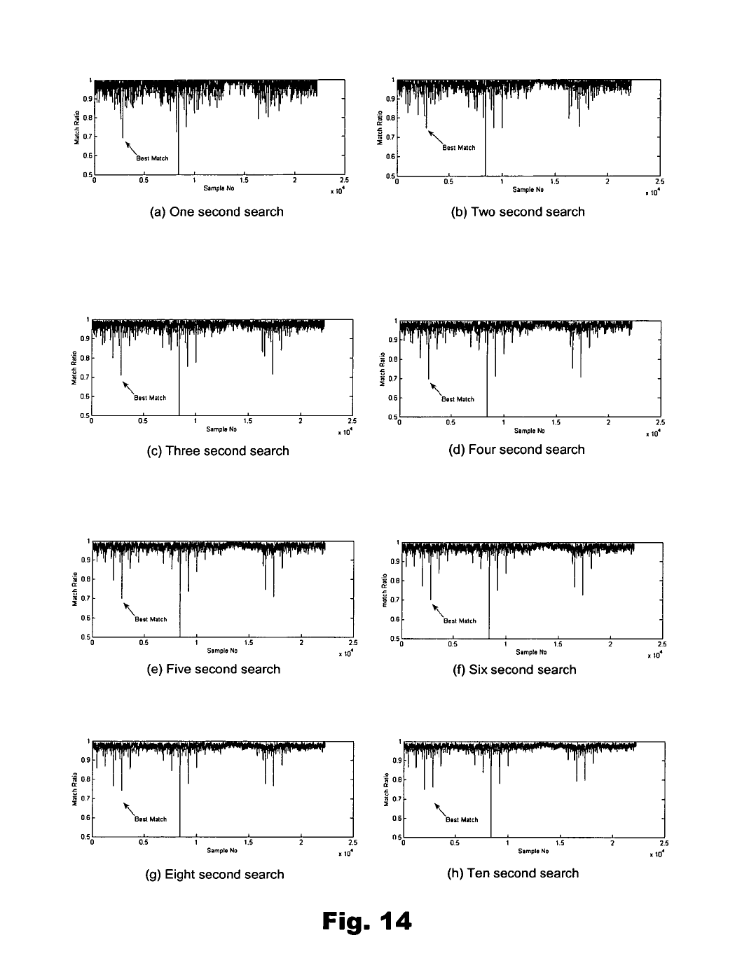

FIG. 14 shows a series of plots illustrating a string matching comparison for different string lengths;

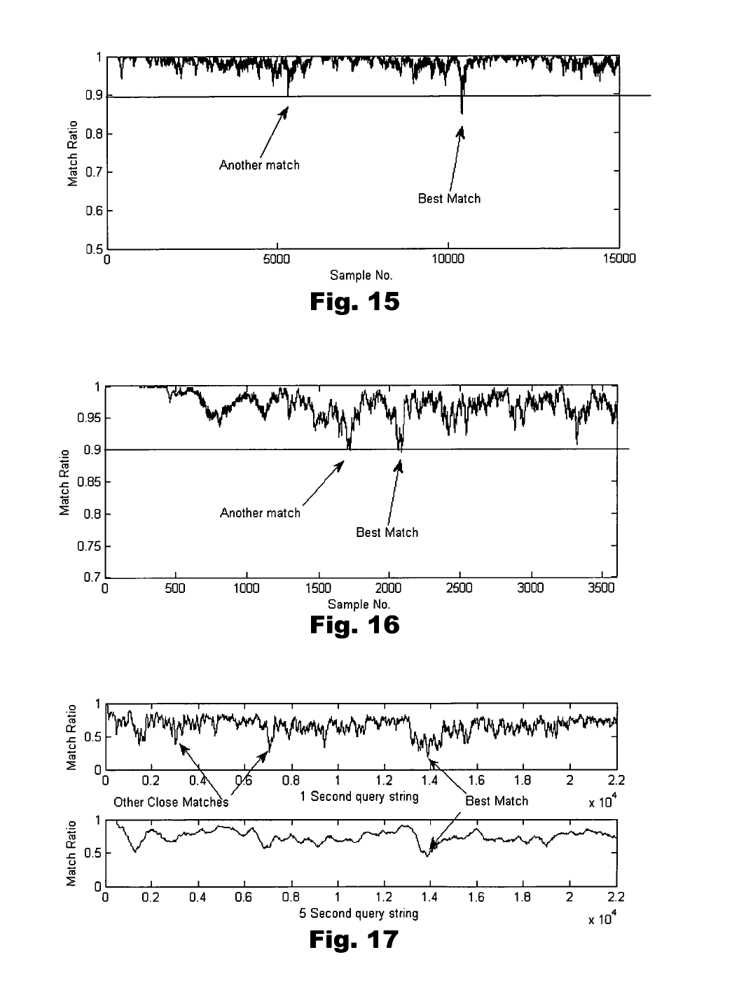

FIG. 15 shows the results of a sample 5 second query on only preceding sections;

FIG. 16 shows the results of a five second query from only 30 seconds of audio;

FIG. 17 shows a comparison between the performance of one and five second query strings;

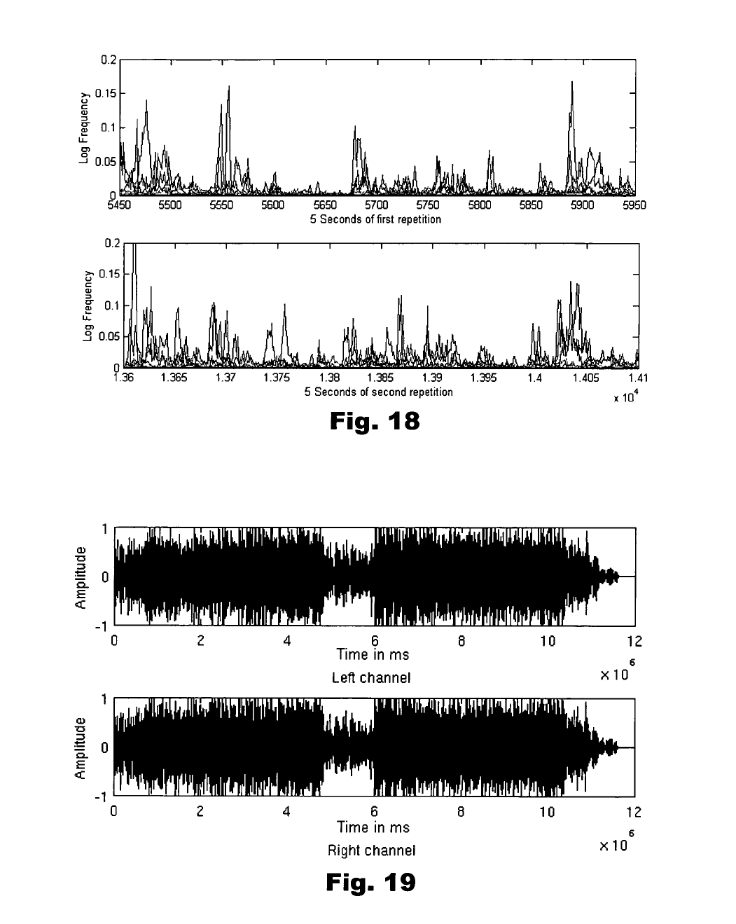

FIG. 18 shows a five second segment of the ASE representation of two ‘similar’ 5 second segments of the song ‘Orinoco Flow’ by the artist Enya;

FIG. 19 shows the plot of a two channel wave audio file of the entire song ‘Orinoco Flow’;

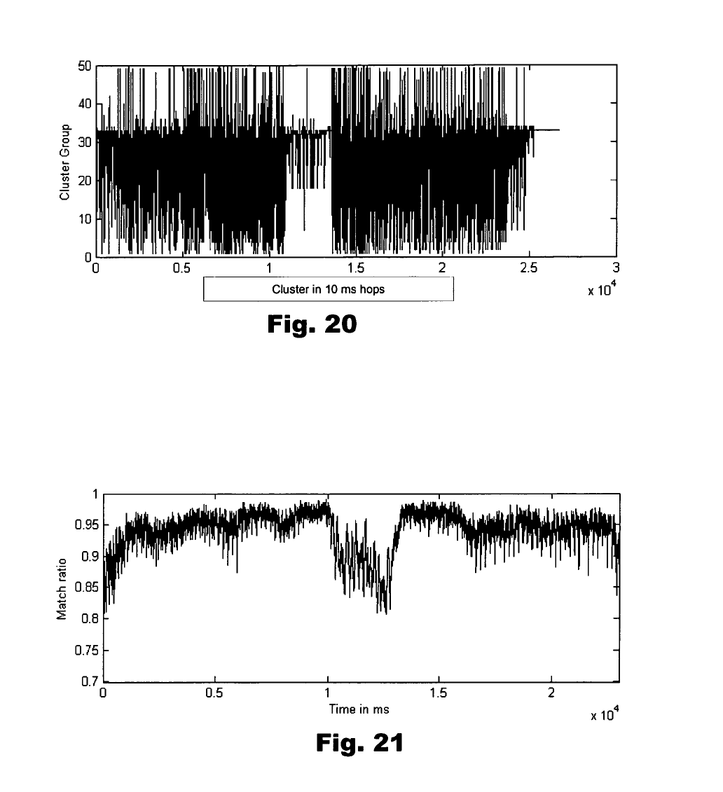

FIG. 20 is the cluster representation of the plot of FIG. 19; and

FIG. 21 is a plot of the match ratio for the 5 second segments shown in FIG. 18.

The invention provides an intelligent music repair system that repairs dropouts in broadcast audio streams on bursty networks. Unlike other forward error correction approaches that attempt to ‘repair’ errors at the packet level the present system uses self-similarity to mask large bursty errors in an audio stream from the listener. The system of the invention utilises the MPEG-7 content descriptions as a base representation of the audio, clusters these into similar groups, and compares large groupings for similarity. It is this similarity identification process that is used on the client side that is used to replace dropouts in the audio stream being received.

The general architecture of the system of the invention can be seen in FIG. 1, illustrating a client/server approach to audio repair. FIG. 1 illustrates the pattern identification components on the server and the music stream repair components on the client as applied to the design stage of application development. On the left of the diagram is a generic representation of the feature extraction process prior to the audio being streamed. The feature extractor 10 analyzes the audio from the audio database 12 prior to streaming and creates a results file 14, which is then stored locally on the server 16 ready for the song to be streamed. The streaming media server 16 then streams the relevant similarity file alongside the audio to the client 18 across the network 20. On the client side the client 18 receives the broadcast and monitors the network bandwidth for delays of the time-dependent packets. When the level of the internal buffer of the audio stream becomes critically low, the similarity file (stored as similarity results 19) is used to determine the best previously received portion of the song to use as a replacement until the network can recover. This is retrieved from a temporary buffer 22 stored on the client machine 18 specifically for this purpose.

In a typical Music Information Retrieval (MIR) system the similarity assessment is performed in three stages:
1. Data reduction
2. Feature extraction
3. Similarity comparisons

One of the aspects of feature extraction is to maintain as high a level of reduction as possible without the loss of pertinent data. The invention makes use of the MPEG-7 features in the audio spectrum envelope (ASE) representation.

The audio spectrum envelope (ASE) of the MPEG-7 standard is a log-frequency power spectrum that can be used to generate a reduced spectrum of the original audio. This is done by summing the energy of the power spectrum within a series of frequency bands. Bands are equally distributed between two frequency edges: loEdge and hiEdge (default values of 62.5 Hz and 16 KHz correspond to the lower/upper limit of hearing—shown in equation 2 below, also FIG. 3). The spectral resolution r of the frequency bands within these limits can be specified based on eight possible values, ranging 1/16 of an octave to 8 octaves as shown in the following equation 1.

r=2^{j}octaves(−4≦j≦+3) (1)

### (Kim et al., 2005)

<AudioDescriptor hiEdge=“16000.0”loEdge=“62.5”octaveResolution=“⅛”xsi:type=“AudioSpectrumEnvelopeType”> (2)

Each ASE vector is extracted every 10 milliseconds from a 30 millisecond frame (window) and thereby gives a compact representation of the spectrogram of the audio.

An overview of the feature extraction components can be seen in FIG. 2, which is a representation of the actions carried out by the feature extraction and similarity measurement components indicated by 11 in FIG. 1. A song is chosen from the database 12, and the appropriate Audio Spectrum Envelope (ASE) for the song is extracted 13 (the ASE shows the audio spectrum on a logarithmic frequency scale). A clustering operation (preferably K-means clustering) is then performed on the extracted data 15. The clustering operation helps to identify similar samples at a granular level. A string matching operation is then performed 17 to identify similarities between large sections of audio. The resultant “best effort” match between similar sections of audio is then stored in the similarity database 14.

A detailed discussion of each of these steps is now provided.

Songs stored in the song database 12 are analysed and the content description generated from the audio is stored in XML format as shown in FIG. 3. The actual file for a typical audio file illustrated is over 487 KB (499,354 bytes) in size and contains over 3700×10 samples for a 37 second long piece of music stored as a wave file. However, the resultant data is now only 6% of its original size. This represents a considerable reduction in the volume of information to be classified but still retains sufficient information for similarity analysis.

The settings used for extraction can be seen in the XML field <AudioDescriptor> in FIG. 3. This stipulates a low and high edge threshold set to “16 kHz” and “62.5 Hz” respectively. These settings are as discussed above, and have been shown to be the upper and lower bounds of the human auditory system (Pan et al., 1995). Sounds above and below these levels are of little value and present no additional information that can be utilised when extracting the frequencies. Experiments with values above and below these produced results with no gain and even worse output as the resultant data was clouded with noise that did not belong to the audio being analysed. It should be noted that the Joanneum Research facility (MPEG-7, 2008) recommend these settings to be used as the default values.

Within the low and high frequencies a resolution of 1 is set for the parameter octaveResolution. This gives a full octave resolution of overlapping frequency bands, which are logarithmically spaced from the low to high frequency threshold settings. (In music, an octave is the interval between one musical pitch and another with half or double its frequency. The octave “relationship is a natural phenomenon which has been referred to as the ‘basic miracle of music’,” the use of which is “common in most musical systems” (Cooper, 1973).) The output of the logarithmic frequency range is the weighted sum of the power spectrum in each logarithmic sub-band. The spectrum according to a logarithmic frequency scale consists of one coefficient representing power between 0 Hz and “low edge”, a series of coefficients representing power in logarithmically spaced bands between “low edge” and “high edge”, and a coefficient representing power above “high edge” resulting in 10 samples for each hop of the audio.

The ASE features have been derived using a hopsize of 10 ms and a frame size of 30 ms. This allows an overlapping of the audio signal samples to give a more even representation of the audio as it changes from frame to frame. An example of the overlapping sampling frames of a waveform can be seen in FIG. 4. In general, more overlap will give more analysis points and therefore smoother results across time, but the computational expense is proportionately greater. The system of the invention generates the ASE descriptions in offline mode and is run once for each audio file stored.

Audio files used in the sample analysis are in “.wav” format, to ensure that audio is of the best possible quality, but it will be understood that other encoding formats may be used.

The invention uses K-means clustering as a method of identifying similarities within different sections of the audio. The choice of starting point of the clusters has a direct result on the outcome of the clustering. The following example shows a matrix of 10 vectors with three k clusters.

FIG. 12 shows a K-means clustering comparison: The starting point in (a) is different from (c), and results in (a) having different cluster choice than (d).

With reference to the accompanying FIG. 12, the plots shown are a series of vectors randomly positioned along the x/y axis. In FIG. 12(a) the starting point for the clusters were positioned randomly, but more biased to the left. This is in contrast to the starting point of the clusters in FIG. 12(c), where the starting point has been changed to be biased to the right of the of the clusters. The change in cluster grouping can be seen in FIG. 12(d), as the data points are now associated with different clusters.

There is no optimum initial cluster positioning but some researchers have given serious consideration to this problem with varying outcomes (Chinrungrueng and Sequin, 1995; Bradley and Fayyad, 1998; Zha et al., 2002). A common rule of thumb, where the initial cluster centroids are initialized evenly across the data, is the most often proposed solution.

In K-means clustering, using an empirical number of clusters provides sufficient grouping based on iterative testing of the audio spectrum envelope data. The ASE data files contain a varying number of vectors depending on the length of the audio, but as each vector contains a finite value in that each sample contains a variable quantity that can be resolved into components, an optimal value of 50 clusters is used, of which a sample output is shown in FIG. 5. This selection allows for a reasonable computational process with the minimum amount of processing power possible whilst maintaining maximum variety. Experiments above this value produced little or no gain, and with processing time increasing exponentially with each increase in cluster number was considered computationally too expensive.

The K-means output results in an array of numbers of 1→x where x is the number of samples in the ASE representation ranging from 1 to 50. A file lasting 30 seconds will result in 3000 clustered samples, and a file lasting 2 minutes 45 seconds will produce 16500 clustered samples. At this stage of the similarity computation process the cognitive representation of music can be construed from the output. Where the human mind automatically detects rhythm and repeating patterns, the clustered output notation can be considered as similar in that each sample has been compared to all other ASE samples and grouped accordingly. Where Jackendoff (1987) presents a hierarchical tree as a representation/notation, a K-means representation conveys the same representative meaning but on a more detailed linear scale. This grouping can be seen in FIG. 6, as follows.

The samples in FIG. 6(a) represent one second of audio with each value representing the 10 ms hop of the ASE extraction. From this figure the level of detail shows the variations in detail between 1 and 50. The K-means plot in FIG. 6(b) shows an expanded time frame window of 20 seconds, and it becomes more difficult to identify individual clusters, but what is easier to see is how differing sections of the audio are being represented. The final plot of the K-means output shown in FIG. 6(c) contains the entire K-means cluster groupings for a full length audio song. To the human eye it is hard to see similarities between sections at this level of detail but what can be clearly seen is the ‘bridge’ section in the middle that is ‘dissimilar’ to any other sections of the audio.

Having an audio file classified and clustered into groups are the preliminary steps to determining similarity between large sections of the file. Where the ASE is a minimalist data representation/description and the K-means grouping is a cluster representation of similar samples at a granular level, the system of the invention makes use of traditional string matching approach to identify large sections of the audio. The k-means clustering identifies and groups 10 ms vectors of audio but this needs to be expanded to a larger window in order to facilitate network dropouts. For example, bursty errors on networks can last for as long as 15 to 20 seconds (Yin et al., 2006; Nafaa et al., 2008), which would mean that if the current system tried to use one identified cluster at a time to repair the gap then it would need to perform the following steps up to two thousand times:
Determine the time-point of failure
Analyse the current cluster
Replace the current section with suitable previous section

This is not a feasible option in regards to computational and processing costs. In addition, this jitter would become a major contributing factor in the resultant audio output to the listener. Using string matching, large sections of the K-means cluster output can be ‘compared’ for overall similarity and the ‘best effort’ match is stored for reference. This file is then used on the client side for reference at a later time on the client machine when dropouts occur.

Various methods of measuring the differences/distance between two fixed length strings are again dependent on the nature of the data. Although in general clusters are ordered numerically, there is no actual value other than as an identifier, and clusters are presented in a nominal scale. For example, considering a sequence of numbers 1, 2, 3, it can be said that 3 is higher than 2 and 1, while 2 is higher than 1. The cluster could be as easily identified by characters or symbols, provided consistency is used in an ordinal scale (i.e. changing the scale can adversely affect the cluster outcome).

By comparing clusters using a hamming scale, any metric value is ignored and only the number of differences between the two are calculated. However, if a ranking system is applied then ordinal variables can be transformed into quantitative variables through normalization. To determine distance between two objects represented by ordinal variables, it is necessary to transform the ordinal scale into a ratio scale. This allows the distance to be calculated by treating the ordinal value as quantitative variables and using Euclidean distance, city block distance, Chebyshev distance, Minkowski distance or the coefficient correlation as distance metrics. Without rank the most effective measure is the hamming distance.

To reduce unnecessary computation, the system of the invention only compares the clusters in previous sections for similarities, as shown in FIG. 7, which illustrates a backward string matching search. This is based on the principle that when attempting a repair, the system of the invention can only use portions of the audio already received, and any sections beyond this have not yet been received by the client and therefore cannot be used. This reduces analysis comparisons considerably in early sections of the audio, but as the time-point progresses the number of comparisons increase exponentially.

A sample output from the example given below in Table 1 shows three different values. The left column is the starting point of the frame to search for, the middle column is the ‘best match’ time-point of all the previous sections and the last column is the matching result—how close the best match is represented in a scale between zero and one, the closer to zero the better the match. The layout of the data was initially to be in a similar XML format as the MPEG-7 data but this was considered to be unnecessary as there is no change of the data layout throughout the entire content of the file. Adding XML tags would be simply to include metadata for song and artist identification which is already stored in the filename. Adding XML tags would also include unnecessary complexity when parsing the file increasing processing needs of the media application.

TABLE 1
String matching output

| Current Time Point | Matching Time Point | Match Result |
|---|---|---|
| 7.413e+03 | 5.44e+02 | 7.1199e−01 |
| 7.414e+03 | 5.45e+02 | 7.1199e−01 |
| 7.415e+03 | 5.46e+02 | 7.1199e−01 |
| 7.416e+03 | 5.47e+02 | 7.1199e−01 |
| 7.417e+03 | 5.48e+02 | 7.1199e−01 |
| 7.418e+03 | 5.49e+02 | 7.0999e−01 |
| 7.419e+03 | 5.50e+02 | 7.0799e−01 |
| 7.420e+03 | 5.51e+02 | 7.0799e−01 |
| 7.421e+03 | 5.52e+02 | 7.0799e−01 |
| 7.422e+03 | 5.53e+02 | 7.0799e−01 |
| 7.423e+03 | 5.54e+02 | 7.0799e−01 |
| 7.424e+03 | 5.55e+02 | 7.0999e−01 |
| 7.425e+03 | 5.56e+02 | 7.1199e−01 |

It will be understood that any audio file format may be used as the audio compression tool for preparing files for broadcast, e.g. Ogg Vorbis. As with other compression techniques, there is no error correction within the stream and packet loss will result in a loss of signal. Using a proprietary media player when fragmented packets are dropped a resend request is called using the Real-Time Control Protocol. The present system however differentiates between fragmented packets and network traffic congestion. As with any media player, the system of the invention makes use of the resend request for corrupt individual packets where one or two packets have time to be resent and will not affect the overall audio output. However, when large dropouts of 5, 10 or 15 seconds occur, this will be unrecoverable and the audio output is affected. It is at this point that the present system uses the previously-received portions in an attempt at masking this error from the listener.

When repairing dropouts in a live audio stream, priority lies in the system's ability to maintain continuity of the output audio alongside a seamless switch between real-time streams being received and buffered portions of the audio, whilst monitoring network bandwidth levels and acting accordingly.

On the client side, there are three requirements to enable a media application to provide for client side audio repair when dropouts occur:
1. Monitor network: The media application is operable to be aware of traffic flow to the network buffer, in the event that if a dropout occurs a timely ‘swap’ can be achieved before the internal network buffer fails.
2. Store locally all previously received portions of the audio: A local ‘buffer’ is used to fill the missing section of audio until the network recovers.
3. Play locally stored audio: As well as being able to play network audio the media player is operable to play audio stored locally on the client machine.

To this end, three pipelines have been created to perform all of the functions listed above simultaneously. Pipelines are a top-level bin—essentially a container object that can be set to a paused or playing state. The state of any elements contained within the pipeline will assume the stopped/ready/paused/playing state of the pipeline when the pipeline state is set. Once a pipeline is set to playing, it will run in a separate thread until it is manually stopped or the end of the data stream is reached.

FIG. 8 illustrates a graphical representation of a sample media handler of the invention with multiple pipelines. The figure shows the bin containing the pipelines necessary for the media application to fulfill the requirements specified above. The media pipeline 30 is the main container/bin with three separate pipelines contained within this. Each of the inner pipelines performs one of the necessary functions to maintain continuity of the audio being relayed to the listener even when dropouts occur.
The ir_pipeline 32 contains the necessary functions to receive an Internet radio broadcast in an ogg vorbis format. Using the gnome3 virtual file source pad as a receiver the stream is thus decoded and passed along until it is handled by the alsasink audio output.
The file_pipeline 34 is created to handle the swap to the file stored locally on the client machine in the event the network fails. It is the media players' ability to perform this function that ‘masks’ a network failure from the listener. When a dropout occurs the ir pipeline is paused and playback is started from the locally stored file.
Whilst the Internet radio broadcast is being played the record_pipeline 36 receives the same broadcast and stores it locally on the machine as a local buffer for future playback. Only one song is ever stored at any one time, each time a new song is played, an ‘end-of-stream’ message is sent to the client application and the last song received is over-written by the new song.

Usually an Internet audio stream is shown as merely the length of time that it is connected to the station, not the length of individual songs. The present system differs in that it resets the GstClock( ) on each new song. This provides a simple “current time-point” that allows the media player to know exactly where in the current song it is, and thereby provides a timestamp as a point of reference when network failure occurs.

As previously described, when the ‘state’ of a pipeline is changed any source/sink pads contained within the pipeline is changed. Upon initial startup of the media application the media pipeline 30 is set to playing by default. This sets the containing pipelines to playing where possible. However, the file pipeline 34 remains in the ready state as a file to play has not been specified. This allows the other two pipelines to run concurrently. The following sample program code shows the creation of the ir_pipeline 32 and setting the state:

/* IR Play elements */
GstElement *ip_pipeline , *ir_source , *ir queue , *ir_parser , *ir_decoder, *ir_conv ,
*ir_sink ;
gboolean setup_ir_play( )
{

unref_ir_pipeline ( ) ;
ir_queue = gst_element_factory_make ( ”queue” , NULL) ;
ir_source = gst_element_factory_make ( ”gnomevfssrc ” , NULL) ;
ir_icydemuxer = gst_element_factory_make ( ”icydemux” , NULL) ;
ir_parser = gst_element_factory_make ( ”oggdemux” , NULL) ;
ir_decoder = gst_element_factory_make ( ” vorbisdec ” , NULL) ;
ir_conv = gst_element_factory_make ( ” audioconvert ” , NULL) ;
. . . . . . . . . . . . . . . . . . . . . . . . . . . . . . . . . . . . . . . . . . .
. . . . . . . . . . . . . . . . . . . . . . . . . . . . . . . . . . . . . . . . . . .
/* put all elements in main bin */
gst_bin_add_many ( GST_BIN ( ir_pipeline ) , ir_source , ir_queue, ir_parser,
ir_decoder , ir_conv , ir_sink , NULL) ;

}

The above code shows, in order, a pipeline created, each element within the pipeline being created and their state set to NULL and the newly created pipeline being added to the main media pipeline bin.

Built into the media application is a message bus that constantly handles internal messages between pipelines and handlers. This message system allows ‘alerts’ to be raised when unexpected events occur, including ‘end-of-stream’ and ‘low internal buffer levels’. A watch method is created to monitor the internal buffer from the audio stream and when a pre-set critical level is reached an underrun message is sent to alert the application of imminent network failure. It should be noted that a network failure is not that a network is completely disconnected from the client machine, but is a network connection that is of such poor signal quality with a low throughput that traffic flow is reduced to an unacceptable level. FIG. 9 shows the process of controlling which pipeline is active at any one time.

When the ir_pipeline 32 is playing (step 100) the file_pipeline 34 is in a ready state. If a network error occurs (102), this may lead the pipeline buffer to underrun, or be in danger of underrunning. When a ‘critical buffer level’ warning is received (104) the media application must swap the audio input from the network to the locally stored file (106) that contains the audio from the start of the audio to the point that the network dropout occurred.

A network failure message calls a procedure that notes the current time-point of the stream and uses this to parse the similarity file (or similarity results 19) already received on the client machine 18 when the current song was started. This file 19 is the output results of the similarity identification previously performed on the server 16. From this, the previously identified ‘best match’ section of the audio is used as a starting point of the local file on the client machine 18.

The file_pipeline 34 is now given focus over the ir_pipeline 32 with their states being changed to playing and paused respectively (108). After a predetermined length of time the buffer level of the ir_pipeline 32 is checked to determine if network traffic has returned to normal (110), if so, then audio output is swapped back to the ir_pipeline 32 (112), and the ir_pipeline buffer cleared (114). Otherwise file playback continues for the same fixed length of time and repeated as necessary. In the event that playback of the locally stored file reaches the end of the time-point from when the network failed it is assumed that network traffic levels will not recover and the application ends audio output and closes the pipelines, waiting for re-initialisation from the user.

Within the framework of the system is the GstClock( ) function, which is used to maintain synchronisation within the pipelines during playback. The media application uses a global clock to monitor and synchronise the pads in each pipeline. The clock time is measured in nanoseconds, and counts time in a forward direction. The GstClock exists because it ensures the playback of media at a specific rate, and this rate is not necessarily the same as the system clock rate. For example, a soundcard may playback at 44.1 kHz, but that does not mean that after exactly 1 second according to the system clock, the soundcard has played back 44.100 samples. This is only true by approximation. Therefore, pipelines with an audio output use the audiosink as a clock provider. This ensures that one second of audio will be played back at the same rate as the soundcard plays back 1 second of audio.

Whenever some part of the pipeline requires the current clock time, it will be requested from the clock through a call to gst_clock_get_time( ). The pipeline that contains all others is used to contain the global clock that all elements in the pipeline use as a base time, which is the clock time at the point where media time is starting from zero. Using the GstClock( ) method, pipelines within the media application can calculate the stream time and synchronise the internal pipelines accordingly. This provides an accurate measure of the current playback time in the currently active pipeline. Using its own internal clock also allows the media application to synchronise swapping between the audio stream and the file stored locally. When a network error occurs the current time-point of the internal clock is used as a reference point when accessing the ‘best-match’ data file as shown in the following code segment:

guint64 len =0 , pos=0 , newpos=0;
GstFormat fmt = GST_FORMAT_TIME;
gst_element_query_position ( ir_sink , &fmt , &pos ) ;
/* convert nanoseconds to centiseconds */
timepos = ( timepos/GST_MSECOND) / 1 0 ;
f=fopen ( datafile , ” r ” ) ;
if ( !f)
{

//Unable to open file!
return 1 ;

}
int linepos = 1 ;
//Lines are in 10 millisecond hops
while ( ! found )
{

fgets ( s , 9 8 , f) ;
if ( linepos == timepos )
{

printf ( ”%s \n” , s ) ;
strTime = s ;
found=TRUE;

}
linepos ++;

}
newTime = atof ( strTime ) ;

This C code above is not optimized in that the ‘similarity’ file must be scanned from the beginning of the file line by line until the current line number count matches the corresponding current time-point. This led to initial tests incurring a jitter effect when swapping from one source to the other. This can be described with reference to FIG. 10.

When an error occurs (point 70), whilst reading the similarity file to find the best possible time to seek to, the radio stream continues playing. This means that when swapping to the previous section (72) on the local audio file, the first half-second or so of audio is not synchronised with the current time-point (74) of the audio stream. This would result in a jitter effect (illustrated in section 76), which may be noticeable to a listener.

A partial fix for this involves reading the entire contents of the ‘similarity’ file into a dynamically created array at the beginning of the audio song being streamed using the following:

while ( fgets ( s , 9 8 , f) != NULL)
{

strTime = s ;
newTime = atof ( strTime ) ;
fData [ linepos ] = newTime ;
l inepos++

}

This allows the time-point to be used as a ‘reference’ pointer in the array fData. Access to memory gives quicker responses than file I/O and gives a much quicker return time of the value held in the ‘similarity’ file, thereby reducing the jitter to a minimum.

At the point of failure the time-point is used as a reference to read from the ‘similarity’ file. Since each comparison in this file is in 10 millisecond hops the current time-point needs to be converted from nanoseconds to centiseconds—for example 105441634000 nanoseconds converts to 10544 centiseconds or 105 seconds

The present system employs a queue element to provide for the swapping of audio sources (i.e. the pipelines) in real-time, without user intervention, whilst maintaining the flow of audio. A queue is the thread boundary element through which the application can force the use of threads. This is done by using a provider/receiver model as shown in FIG. 11. The model illustrated utilises a sender element 80 and a receiver element 82. The sender element 80 is coupled to a first queue provider 84, which is operable to receive commands from the sender element 80 which are added to send queue 85.

Send queue 85 is transmitted to the second queue provider 86, where it is received as the dispatch queue 87. The second queue provider 86 is coupled with the receiver element 82, and is operable to deliver the items of the dispatch queue 87 to the receiver element 82. This configuration results in an effective logical connection between the sender element 80 and the receiver element 82.

The use of a queue element acts both as a means to make data throughput between threads thread safe, and it also acts as a buffer between elements.

Queues have several GObject properties to be configured for specific uses. For example, the lower and upper threshold level of data to be held by the element can be set. If there is less data than set in the lower threshold it will block output to the following element and if there is more data than set in the upper threshold, it will block input or drop data from the preceding element. It is through this element that the message bus receives the ‘buffer underrun’ when incoming network traffic reaches a critically low state.

It is important to note that the data flow from the source pad of the element before the queue and the sink pad of the element after the queue is synchronous. As data is passed returning messages can be sent, for example when a ‘buffer full’ notification is sent back through the queue to notify the file source sink to pause the data flow. Within pipelines, scheduling is either push-based or pull-based, depending on which mode is supported by the particular element. If elements support random access to data, such as the gnomevfsink Internet radio source element, then elements downstream in the pipeline become the entry point of this group, i.e. the element controlling the scheduling of other elements. In the case of the queue element the entry point pulls data from the upstream gnomevfssink and pushes data downstream to the codecs, and passes a ‘buffer full’ message upstream from the codecs to the gnomevfssink thereby calling data handling functions on either source or sink pads within the element.

### Sample Results

As previously noted, the number of clusters used is set to 50. Values above this offer no gain for the level of detail attained. FIG. 13 shows a 5 second sample of audio with clusters of 30, 40 and 50 plotted. The different groupings for each 10 ms sample can be seen in both box A and box B. Depending on the number of k clusters specified each sample will be classified differently. As indicated by the scale, the samples using 30 clusters are shown as *, samples for a value of 40 clusters are shown as •, and the 50 cluster grouping is shown as x. In box A a distinct difference between the values can be seen, where the 30 cluster group has been identified predominantly as between 0 and 5. The 30 cluster grouping in Box A also have a high number associated with groups at the high end of clusters between 25 and 30, this shows a high level of inconsistency between samples.

Although the k cluster number is arbitrarily defined initially, consistency between clusters improves as the number of groupings increase. In FIG. 13 the highlighted area of Box B shows the k cluster of 50 predominantly classified as the same cluster, whereas the 30 and 40 clusters produced more varied classifications. Tests involving k clusters over 50 can produce similar results, but create large increases in processing time.

Table 2 below presents the number of calculations required based on the number of k clusters chosen. The number of computations do not increase on a linear or exponential level, but are based on the complexity of the music and its composition as well as the duration of the audio. Owing to the composition of song A, it requires more calculations. Song A is a 12 Bar Blues sample audio used as a testbed. Since it contains a high level of variations between time frames, centroids and distances need to be re-evaluated more frequently. Songs B, C and D are a random collection of audio files from a main music collection. The basic descriptions of the songs used in the test are presented in Table 3, listing song duration, and degree to which the audio file can be described as corresponding to the Western Tonal Format of audio (WTF).

TABLE 2
Number of K cluster computations relative to the size of K

Iterations

| Clusters | Song A | Song B | Song C | Song D |
|---|---|---|---|---|
| 30 | 8040 | 3270 | 4410 | 6240 |
| 40 | 6520 | 13280 | 6650 | 10160 |
| 50 | 8750 | 12000 | 11000 | 13550 |
| 60 | 10260 | 17040 | 15060 | 16800 |
| 80 | 13520 | 19680 | 31360 | 18080 |
| 100 | 19700 | 30700 | 39300 | 45700 |

TABLE 3
Properties of songs under test

| | Audio Properties | |
|---|---|---|
| Song | Song Duration | Degree of WTF |
| A | 3 min 52 secs | Medium |
| B | 3 min 52 secs | Medium |
| C | 3 min 12 secs | High |
| D | 4 min 26 sec | Low |

When a choice of k clusters is set to above 40, a steady increase of computations can be seen in song A. This is contradicted when using clusters below the level of 40 where songs A, B, C and D all produce varying results. This can partially be attributed to the limited number of k clusters that differing values can be assigned to (Zha et al., 2002; Kriegel et al., 2005). More variations with fewer clusters mean more comparisons, since one sample with a high value can offset the centroid of the associated cluster, and as a result needs to be adjusted more frequently.

Having one 10 ms sample classified presents the audio in a readable format that allows larger sections to be compared for similarities. Introduced above is the approach of using string matching for comparing n length of clusters at time-point y with n length at a preceding time-point x within the same audio file.

Investigations into string length can be seen in FIG. 14, which shows a string matching comparison, using a string length equivalent to one second in FIG. 14(a), stepped by one second up to FIG. 14(f), and stepped by two seconds in FIGS. 14 (g) and (h).

Within this figure are 10 sub-figures showing the results for a complete search of a file given a specific ‘query’. The query in question is a fixed length string taken from the k-means clustered output which results in the following output:
. . . 6,2,23,17,42,36,35,16,23,11,35,16,2,6,35,16,6, . . .
. . . ,2,35,41,40,46,42,17, . . .

A query string of one second in length contains 100 values and the entire clustered output of an audio file contains over 23,000 identified clusters. As an example of success the query string is taken from a random point in the middle of the file without any pre-conceptions, i.e. it is not known whether the query string time-point is part of the chorus or a verse or even a bridge. This query string is then compared with the entirety of the clustered file and noted as to how ‘close’ a match it is to each segment across all time-points from beginning to end.

The closer to a ranked score of zero the better the match. Within each figure one clear ‘match value’ can be seen. This is the time-point at which the original query string was sampled from, and will always give an exact match. Other matching points have been shown as the ‘best match’ in the first quarter of the song, as indicated in each figure.

However, by looking at the number of matches across the full duration of the audio file, this indicates a clear result in regards to other sections of the audio. Although the ‘best match’ shown in Table 4 below shows an average match ratio of approximately 0.7 in relation to the nearest other ‘matches’, this is considerably close.

TABLE 4
String comparison results for 1 to 10 seconds

| Search | | |
|---|---|---|
| String in | Match | No. Matches |
| Seconds | Result | Below .85 |
| 1 | .6931 | 6 |
| 2 | .7463 | 5 |
| 3 | .711 | 5 |
| 4 | .6983 | 4 |
| 5 | .7005 | 4 |
| 6 | .7006 | 4 |
| 8 | .7416 | 3 |
| 10 | .7662 | 5 |

Also shown in Table 4 is the number of matches that have been found to be below 0.85. Although the best score in the table is 0.6931, it can be clearly seen that other sections have been identified as similar—this gives an indication of the repetitiveness of the audio. However, as the initial query string length increases, either the ‘score’ decreases or the number of matches found decreases, giving a reduction in accuracy when determining the best match. In addition, the need to replace sections of audio when dropouts occur greater than one second eliminates the choice of using one or two second length queries as sample criteria when searching for matches.

In FIGS. 14 (a) and (b), a very close match can be seen marginally to the left of the ‘original query’ time-point. This in theory could cause problems when trying to repair bursty errors, as it is too close to the live stream time-point and the media application will only have a very limited time frame for the network to recover. A balance between the extreme lengths of the queries as shown in Table 4 can be seen by using a 5 second length as shown in FIG. 14(e).

While FIG. 14 shows the success of matching sections of audio found throughout the audio file, for the purpose of repairing bursty dropouts the media application of the system of the invention can only use previously received portions of the live stream received up to the point at which network bandwidth/throughput becomes unstable.

FIG. 15 shows another random timepoint chosen near the end of a different song than the file used in FIG. 14. Using five seconds as a query length, a ‘successful’ match can clearly be seen as identified by the best match indicator in the Fig. Only one other possible match can be seen, and this match has a relatively low match ratio of 0.87. All other comparisons resulted in near and above 0.95—a ‘match’ at this level would be considered almost unusable.

FIG. 16 represents a ‘worst case scenario’ for the system: if a network dropout occurs near the beginning of a song. FIG. 16 shows a five second query result of a dropout occurring after 30 seconds of audio have been received. The ‘best’ match ratio is now only just below 0.89 and only marginally better than any of the other samples. Using this portion of audio as a starting point to replace the break in the live stream will simply mask the error from the listener but it will be apparent. At this level the attempted repair is merely to replace a complete loss of signal to minimise the level of distraction caused to the listener.

Table 5 shows the average match percentage for cluster string lengths of between 1 second and 20 seconds. As the time span increases the accuracy of the match decreases. It should be noted in the table the jump between 0.6534 for a 1 second query string and 0.6994 for a two second query string. This is owing to too many false positives for a match result for such a short query string.

TABLE 5
Average match ratio across all song segments

| Seconds | Average Match |
|---|---|
| 1 | 0.6534 |
| 2 | 0.6994 |
| 3 | 0.7224 |
| 4 | 0.7350 |
| 5 | 0.7456 |
| 6 | 0.7521 |
| 7 | 0.7581 |
| 8 | 0.7726 |
| 9 | 0.7864 |
| 10 | 0.7918 |
| 12 | 0.8007 |
| 15 | 0.8121 |
| 20 | 0.8365 |

The issue of too many ‘successful’ matches can be seen more clearly in FIG. 17, which shows a comparison of one and five second query strings. Both the one and five second queries returned the same time point as the best possible match for the starting time point of the query. However, additional matches below the best match result using five seconds were found using only one second of audio. This can lead to sections of audio that may be used which are not an accurate replacement for dropouts of over one second in length. Using a five second length reduces this possibility, whilst increasing the possibility of the audio following on from the query string time-point still being correct.

One of the relatively problematic songs used for testing purposes was the song “Orinoco Flow”, by the artist Enya. Although the structure of the songs by this artist are repetitive in principle, they do not strictly adhere to the western tonal format definition. ‘Orinoco Flow’ for example follows the verse/chorus/bridge/verse/chorus structure. However, repeats of the chorus are not composed exactly the same each time they are repeated. This presents problems when matching ‘chorus’ sections as well as verses and bridges.

The match ratio expected for a verse is expected to be lower than for a chorus, where the verse usually contains the same underlying music (guitar, drums, piano) in the same repeated manner for different sections. The lyrics, however, can and do change for each verse throughout the song, thereby leading to a lower match percentage. In the case of work by Enya however, not only do the verses change but the chorus is different also. To add to the complexity of an uncertain structure, Enya changes the underlying music but not the lyrics for each repetition of the chorus. For example the drum rhythm and guitar rhythm appear ‘out of sync’ compared to other repetitions of the chorus.

In FIG. 18, plots of two ‘similar’ 5 second segments of the ASE representation of the song ‘Orinoco Flow’ are shown. The upper plot shows a five second segment of the ASE representation of the first chorus. The time-point it starts at is relative to the start of the first lyric in the chorus. When compared to the next time the same lyrics are repeated, as shown in the lower plot, an overall difference of the audio composition for the equivalent section can be seen.

FIG. 19 shows the full audio file in a wave representation, and FIG. 20 shows the same information in the clustered format. Clear similarities of the overall structure of the music can be clearly seen: The bridge section is clearly visible in both figures, as well as similarities between the start and end of the song in the way the overall strength of the wave representation is somewhat similarly represented in the clustered representation. It can be implied from this that ‘best effort’ results would be similar to previous examples.

However, shown in FIG. 21 is the match ratio result for the time segments used in FIG. 18, and it can be seen that the corresponding ‘best match’ is not the most optimal position. The correct time point is actually 10 seconds following on from this point. It can also be seen as a high match ratio at the beginning of the audio, where no lyrics are performed. To explain the reason for the ‘miss-classification’ occurring in the case of this song, the music is timed differently for each different repetition of the lyrics in further sections.

Throughout almost the entirety of the song, a repetitive music pattern is played, as lyrics change the music remains the same during both verse and chorus. The only change from this occurs during the bridge section. The result of this continuous repetition produces a ‘best match’ because the music frequencies are more dominant than the lyrics. This leads to a ‘false positive’ match where the underlying music is the same but the section matched is not ‘correct’.

Table 6 shows a comparison of the match ratio for ‘Orinoco Flow’ performed by Enya alongside the difference between the average match ratio for durations of one second to ten seconds. The results ‘indicate’ a better match for time lengths of over two seconds, but many of these matches may be ‘false positives’. This table, along with FIG. 21, shows how music that is not strictly in western tonal format (WTF) can produce what appears to be good match sections, but in reality are poor ‘substitutes’ when better sections should have been identified.

TABLE 6
A comparison of match ratio across
all song segments with Orinoco Flow

| Search String | | Difference |
|---|---|---|
| in Seconds | Match Result | from Average |
| 1 | .6737 | −0.0194 |
| 2 | .7260 | −0.0203 |
| 3 | .7523 | +0.0413 |
| 4 | .7680 | +0.0697 |
| 5 | .7795 | +0.0790 |
| 6 | .7958 | +0.0952 |
| 8 | .8145 | +0.0729 |
| 10 | .8339 | +0.0677 |

Regarding the ‘best effort’ approach of the system of the invention, using the ASE representation as a meaningful ‘true’ representation and an audio analysis tool called ‘Sonic Visualiser’ to present the same or ‘similar’ sections of the actual audio in the form of a spectrogram, the identified ‘best effort’ matches can be more easily displayed.

The optimum replacement for specific time points within an audio broadcast has been discussed above. Using Sonic Visualiser these identified sections can be visually represented not as a ‘match ratio’, but as a spectrogram representation (a spectrogram shows how the spectral density of a signal changes across time).

The most evident repetition among the range of frequencies is generally seen at the lower end of the scale, where strong base tones are more applicable (Olson, 1967). Base drums and male vocals can be more dominant within this range (the vocal range of a typical adult male will have a fundamental frequency of from 85 to 155 Hz, and an adult female from 165 to 255 Hz (Titze and Martin, 1998)). More evident at this level is the repetition of the frequencies over the fixed temporal length of the sample. Close similarities between duration and power can be seen across FIGS. 14(a) to (c).

Computing the two-dimensional correlation coefficient between the two similarly defined matrices produces a value of a high correlation and a low mean difference, as shown in Table 7 with matrices A and B. These results can be compared to a segment of audio from a dissimilar match that produces a low correlation and a proportionately higher mean difference as shown in the comparison of matrices A and C. It is noted here that correlation measures the strength of a linear relationship between the two variables and this linear relationship can be false. A correlation coefficient of zero does not mean the two variables are independent but that there is no linear relationship between them. However, when combined with the mean differences between the vectors and the visual representations the accuracy between matches can be clearly defined.

TABLE 7
A comparison of correlation and mean difference
between 3 different audio segments

| Matrices | | |
|---|---|---|
| Compared | Correlation | Mean Difference |
| A ∩ B | 0.7204 | 0.000066657 |
| A ∩ C | 0.2491 | 0.00078542 |

The overall best match found across all audio files tested was a match ratio of 0.448, yet the above samples in FIGS. 14 and 15 were based on a 0.7 match. This measure of similarity is used to obtain the best option for repair. As a representative example, the samples chosen for comparison were arbitrary and no known verse or chorus structure was known.

The primary aim of the invention is to repair dropouts with a best possible match from all previously received sections, and not only to repair a ‘verse dropout’ with a previous ‘verse section’. For this reason best possible matches of values as high as 0.9 may be used during the first rendition of a verse or chorus, and will produce audio quality that can only be described as subjective at best.

The invention is not limited to the embodiment described herein but can be amended or modified without departing from the scope of the present invention.

1. A method of analysing the self-similarity of an audio file, the method comprising the steps of:
obtaining the audio spectrum envelope data of an audio file to be analysed;
performing a clustering operation on the spectrum envelope data to produce a clustered set of data;
for a first portion of the clustered data, performing a string matching operation on at least one other portion of the clustered data; and
based on the results of the string matching operation, determining the at least one other portion of the clustered data most similar to said first portion of the clustered data.

2. A method as claimed in claim 1, wherein said string matching operation is carried out on the portions of said clustered data preceding said first portion.

3. A method as claimed in claim 1, wherein said step of obtaining the audio spectrum envelope comprises:
obtaining an audio file to be analysed; and
extracting the audio spectrum envelope data of said audio file.

4. A method as claimed in claim 1, further comprising the step of creating a self-similarity record for said audio file, the self-similarity record containing details of the most similar portion of the clustered data for each portion of said audio file.

5. A method as claimed in claim 1, further comprising the step of appending said audio file with a tag, the tag including details of the most similar portion of the clustered data for each portion of said audio file.

6. A method as claimed in claim 4, further comprising the step of transmitting the audio file and substantially simultaneously transmitting the self-similarity record across a network to a user for playback.

7. A method as claimed in claim 1, wherein the clustering operation is a K-means clustering operation.

8. A method as claimed in claim 1, wherein the cluster number is from 30 to 70.

9. A method as claimed in claim 8, wherein the cluster number is from 45 to 55.

10. A method as claimed in claim 9, wherein the cluster number is 50.

11. A method as claimed in claim 1, wherein the cluster starting points are equally spaced across the data.

12. A method as claimed in claim 1, wherein the audio spectrum envelope is chosen to have a hop size of between 1 ms and 20 ms.

13. A method as claimed in claim 12, wherein the audio spectrum envelope is chosen to have a 10 ms hop size.

14. A method as claimed in claim 1, wherein the number of frequency bands of the audio spectrum envelope is chosen to be between 6 and 10.

15. A method as claimed in claim 1, wherein the clustering operation uses the Euclidian distance metric.

16. A method as claimed in claim 1, wherein the step of performing a string matching operation comprises measuring the distance between compared strings in an ordinal scale.

17. A method as claimed in claim 1, wherein the step of performing a string matching operation comprises measuring the distance between compared strings using hamming distance.

18. A method of repairing an audio stream transmitted over a network based on self-similarity, the method comprising the steps of:
receiving an audio stream over a network;
receiving similarity data detailing the at least one other portion of the audio stream most similar to a given portion of said audio stream;
when a network error occurs for a portion of the audio stream, replacing said portion of said audio stream with that portion of the audio stream most similar to said portion, based on said similarity data.

19. A non-transitory computer-readable storage medium having recorded thereon instructions which, when executed on a computer, are operable to implement a method of analysing the self-similarity of an audio file, the method comprising the steps of:
obtaining the audio spectrum envelope data of an audio file to be analysed;
performing a clustering operation on the spectrum envelope data to produce a clustered set of data;
for a first portion of the clustered data, performing a string matching operation on at least one other portion of the clustered data; and
based on the results of the string matching operation, determining the at least one other portion of the clustered data most similar to said first portion of the clustered data.

20. A non-transitory computer-readable storage medium having recorded thereon instructions which, when executed on a computer, are operable to implement a method of repairing an audio stream transmitted over a network based on self-similarity, the method comprising the steps of:
receiving an audio stream over a network;
receiving similarity data detailing the at least one other portion of the audio stream most similar to a given portion of said audio stream; and
when a network error occurs for a portion of the audio stream, replacing said portion of said audio stream with that portion of the audio stream most similar to said portion, based on said similarity data.
